(19) United States
(12) Patent Application Publication
(10) Pub. No.: US 2018/0141253 A1
(43) Pub. Date: May 24, 2018

(54) Method of forming layering structure of plastic flooring

(71) Applicant: Lu Ding Yi, JiangSU (CN)

(72) Inventor: Lu Ding Yi, JiangSU (CN)

(21) Appl. No.: 15/604,689

(22) Filed: May 25, 2017

(30) Foreign Application Priority Data
Nov. 23, 2016 (CN) 201611047571.6

(51) Int. Cl. B29C 47/00; B29C 65/56; B29C 65/78; B29C 65/00; B32B 27/30; B32B 27/22; B32B 27/06; B32B 37/10

(52) U.S. Cl. CPC B29C 47/004; B29K 2027/06; B29C 47/0021; B29C 47/0019; B29C 47/0064; B29C 47/0047; B29C 65/56; B29C 65/7894; B29C 66/45; B29C 66/727; B32B 27/304; B32B 27/22; B32B 27/065; B32B 37/10; B29C 47/0004

(57) ABSTRACT

A layering structure of plastic flooring is formed by way of an extruder, a rolling conveyor, and a roller unit, and the plastic flooring contains a substrate, a printing layer, and an abrasion resistant layer. The substrate includes at least two sheets which are one-piece extrusion formed by using the extruder so that the at least one sheet stack together. The printing layer is arranged on a top of the substrate and has patterns printed thereon, and the abrasion resistant layer is formed on the printing layer. After the substrate is one-piece extrusion formed, the printing layer and the abrasion resistant layer are conveyed to the roller unit by the rolling conveyor so that the substrate, the printing layer, and the abrasion resistant layer are rolled and pressed together by the roller unit.

### FIELD OF THE INVENTION

The present invention relates to plastic flooring which forms registration patterns thereon.

### BACKGROUND OF THE INVENTION

Conventional plastic flooring contains: a substrate, a printing film and abrasion resistance film which are pressed by three press rollers or six press rollers of a rolling machine so as to form three-dimensional patterns thereon. However, the substrate and the printing film cannot be conveyed synchronously, so the substrate cannot correspond to pressing patterns of the printing film, and a depressed part and the raised part of the pressing patterns cannot align with a pattern portion of each press roller accurately.

The present invention has arisen to mitigate and/or obviate the afore-described disadvantages.

### SUMMARY OF THE INVENTION

The primary objective of the present invention is to provide a layering structure of plastic flooring which is stiff and flexible.

Another objective of the present invention is to provide layering structure of plastic flooring which is manufactured in an automation manner.

To obtain the above objectives, a layering structure of plastic flooring provided by the present invention is formed by way of an extruder, a rolling conveyor, and a roller unit, and the plastic flooring contains: a substrate, a printing layer, and an abrasion resistant layer.

The substrate includes at least two sheets which are one-piece extrusion formed by using the extruder so that the at least one sheet stack together.

The printing layer is arranged on a top of the substrate and has patterns printed thereon.

The abrasion resistant layer is formed on the printing layer.

After the substrate is one-piece extrusion formed, the printing layer and the abrasion resistant layer are conveyed to the roller unit by the rolling conveyor so that the substrate, the printing layer, and the abrasion resistant layer are rolled and pressed together by the roller unit.

In one embodiment, the substrate includes a first sheet made of PVC material in which plasticizer is added so that the first sheet is flexible, and the substrate includes a second sheet located on the first sheet and made of PVC material in which the plasticizer is not added so that the second sheet is stiff.

In one embodiment, the substrate includes a first sheet made of PVC material in which plasticizer is not added so that the first sheet is stiff, a second sheet located on the first sheet and made of PVC material in which vesicant is added so that the second sheet is flexible, and a third sheet located on the second sheet and made of PVC material in which the plasticizer is not added so that the third sheet is stiff.

In one embodiment, the substrate includes a first sheet made of PVC material in which plasticizer is added so that the first sheet is flexible, a second sheet located on the first sheet and made of PVC material in which vesicant is added so that the second sheet is flexible, and a third sheet located on the second sheet and made of PVC material in which the plasticizer is not added so that the third sheet is stiff.

In one embodiment, the substrate includes a first sheet made of PVC material in which plasticizer is added so that the first sheet is flexible, a second sheet made of PVC material in which vesicant is not added so that the second sheet is stiff, and a third sheet located on the second sheet and made of PVC material in which the plasticizer is added so that the third sheet is flexible.

In one embodiment, the substrate includes a first sheet made of PVC material in which plasticizer is added so that the first sheet is flexible, a second sheet located on the first sheet and made of PVC material in which gas is fed so that the second sheet foams and is flexible, and a third sheet located on the second sheet and made of PVC material in which the plasticizer is added so that the third sheet is flexible.

Preferably, a pattern part is fixed on a bottom of the substrate and is a PVC film.

Preferably, the rolling conveyor includes a first rolling mechanism for rolling the abrasion resistant layer, a second rolling mechanism for rolling the printing layer, a first pressing mechanism for pressing the abrasion resistant layer, a second pressing mechanism for pressing the printing layer, and a guiding mechanism for guiding the printing layer; wherein the abrasion resistant layer is rolled, pressed, and delivered to the roller unit by way of the second rolling mechanism and the second pressing mechanism; wherein the printing layer is rolled, pressed, and delivered to the roller unit by means of the second rolling mechanism, the second pressing mechanism, and the guiding mechanism.

Preferably, the roller unit includes a first roller, a second roller, a third roller, a fourth roller, and a support frame, wherein the first roller is fixed on a lower end of the support frame, the second roller is located on the first roller, the third roller is disposed above the second roller, and the fourth roller is secured on the third roller, such that the substrate is guided into the roller unit via the first roller and the second roller, and the substrate is delivered across the third roller and the fourth roller along the second roller, wherein before the substrate is delivered across the third roller and the fourth roller, the printing layer and the abrasion resistant layer are conveyed to the roller unit by the rolling conveyor so that the printing layer stacks on the substrate, and the abrasion resistant layer stacks on the printing layer, hence the substrate, the printing layer, and the abrasion resistant layer are rolled and pressed together by the third roller and the fourth roller of the roller unit

### BRIEF DESCRIPTION OF THE DRAWINGS

FIG. 1 is a schematic view of a rolling conveyor and a roller unit according to a preferred embodiment of the present invention.

FIG. 2 is a schematic view of another roller unit according to a preferred embodiment of the present invention.

FIG. 3 is a schematic view of an extruder according to a preferred embodiment of the present invention.

FIG. 4 is a schematic view showing the assembly of a layering structure of plastic flooring according to a preferred embodiment of the present invention.

FIG. 5 is a schematic view showing the assembly of a layering structure of plastic flooring according to another preferred embodiment of the present invention.

FIG. 6 is a schematic view showing the assembly of a layering structure of plastic flooring according to another preferred embodiment of the present invention.

FIG. 7 is a schematic view showing the assembly of a layering structure of plastic flooring according to another preferred embodiment of the present invention.

FIG. 8 is a schematic view showing the assembly of a layering structure of plastic flooring according to another preferred embodiment of the present invention.

FIG. 9 is a schematic view showing the assembly of a layering structure of plastic flooring according to another preferred embodiment of the present invention.

FIG. 10 is a schematic view showing the assembly of a pattern part and the layering structure of the plastic flooring according to the preferred embodiment of the present invention.

### DETAILED DESCRIPTION OF THE PREFERRED EMBODIMENTS

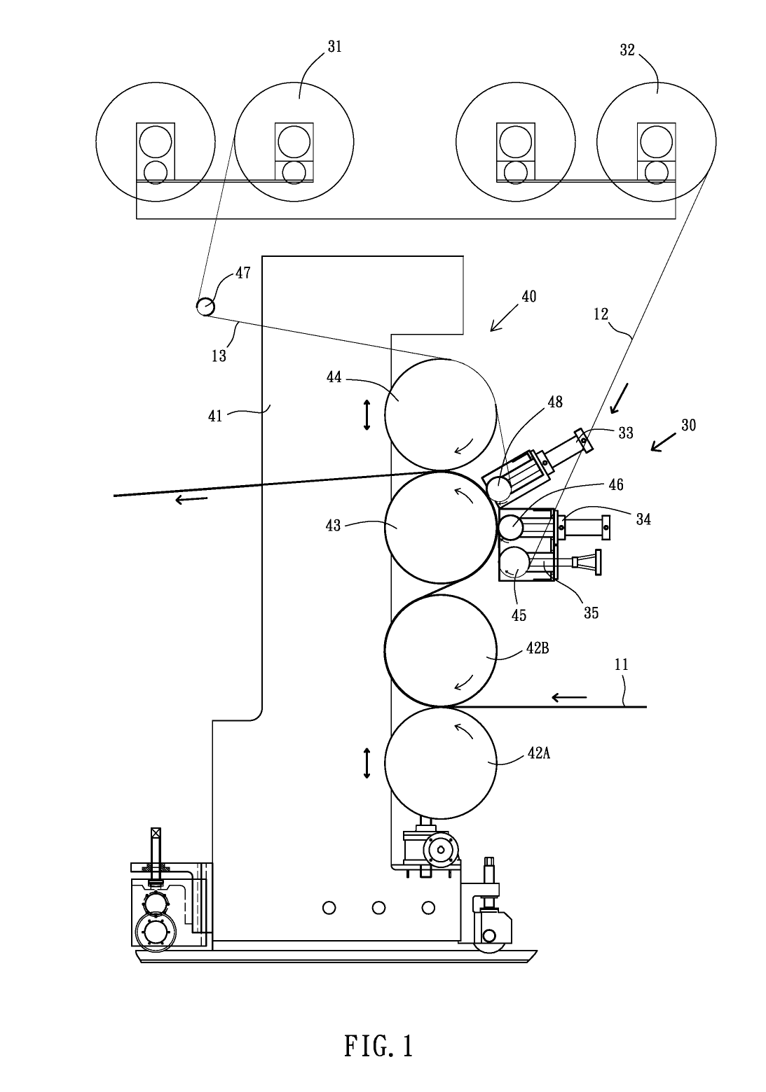

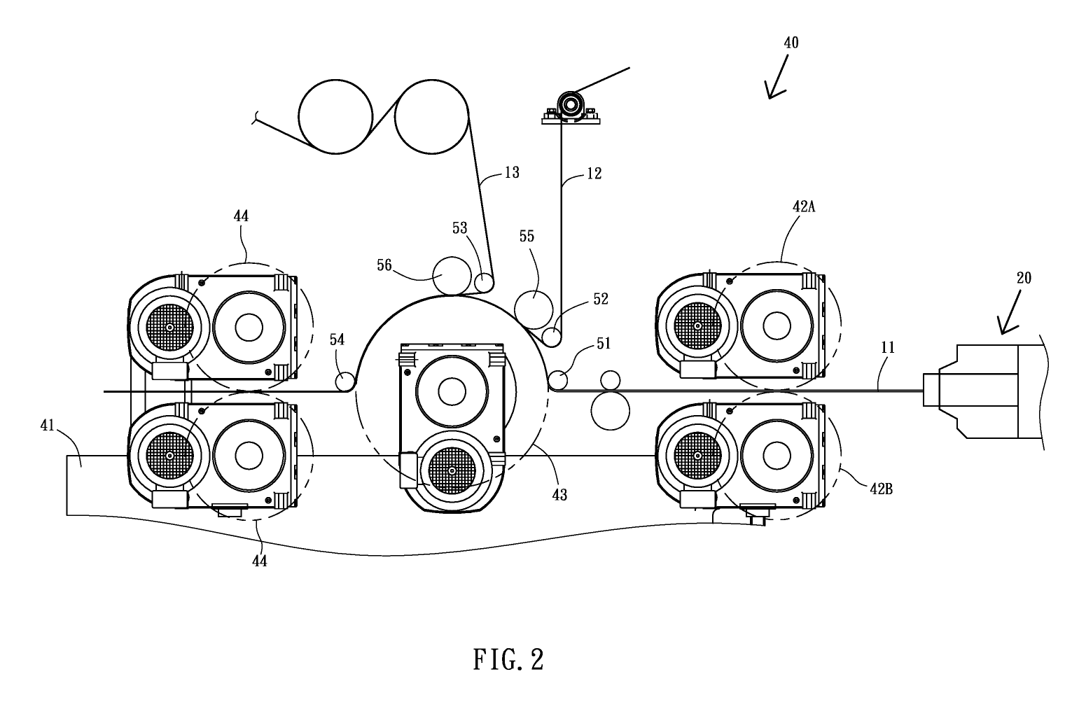

With reference to FIGS. 1 to 10, a layering structure of plastic flooring 10 according to a preferred embodiment of the present invention is formed by way of an extruder 20, a rolling conveyor 30, and a roller unit 40.

The plastic flooring 10 comprises a substrate 11, a printing layer 12, and an abrasion resistant layer 13. The substrate 11 includes at least two sheets which are one-piece extrusion formed by using the extruder 20 so that the at least one sheet stack together.

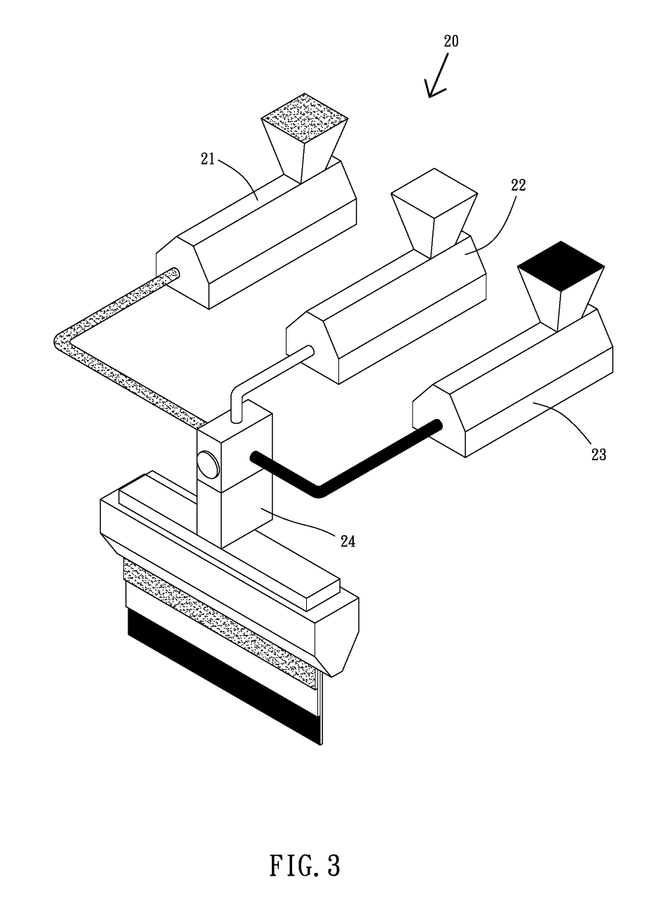

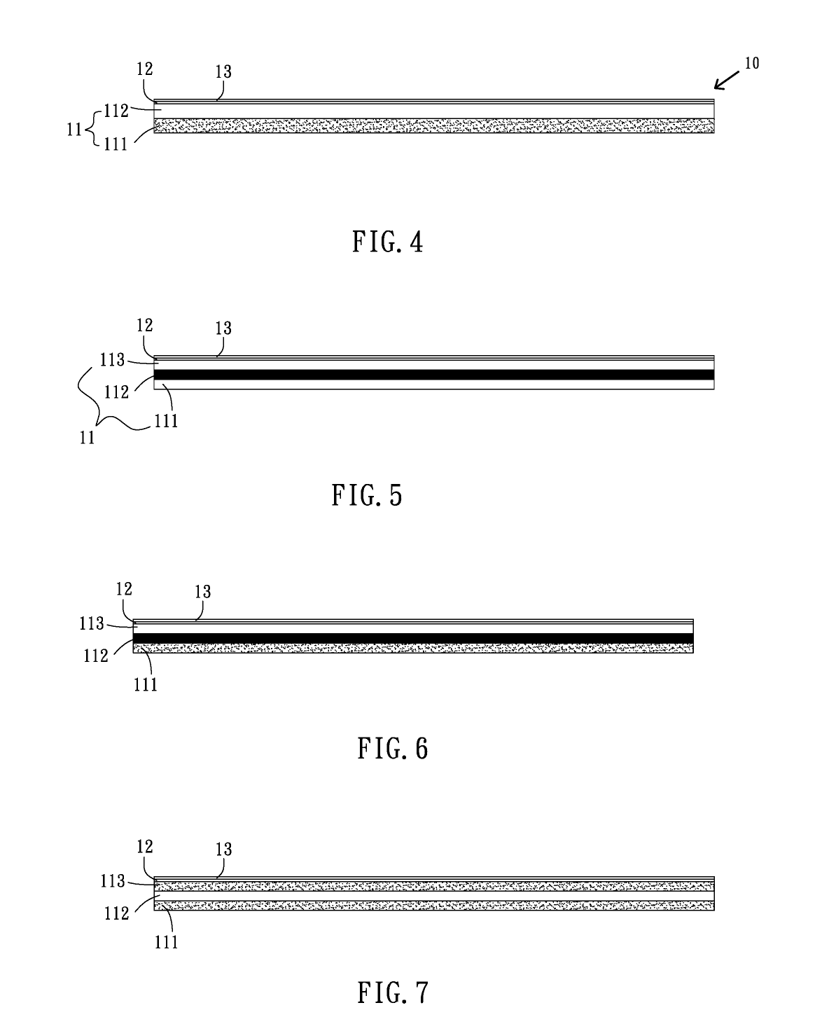

Referring to FIG. 4, the substrate 11 includes a first sheet 111 made of PVC material in which plasticizer is added so that the first sheet 111 is flexible, and the substrate 11 includes a second sheet 112 located on the first sheet 111 and made of PVC material in which the plasticizer is not added so that the second sheet 112 is stiff. Alternatively, the first sheet 111 is made of foam material in which polyvinyl chloride (PVC) and inert gas are added. In another embodiment, the first sheet 111 is made of foam material in which foaming agent is added so that the first sheet 1 is stiff, and the second sheet 112 is made of PVC material in which the plasticizer is added so that the second sheet 112 is flexible.

As shown in FIG. 5, the substrate 11 includes a first sheet 111 made of PVC material in which plasticizer is not added so that the first sheet 111 is stiff, a second sheet 112 located on the first sheet 111 and made of PVC material in which vesicant is added so that the second sheet 112 is flexible, and a third sheet 113 located on the second sheet 112, wherein the third sheet 113 is made of PVC material in which the plasticizer is not added so that the third sheet 112 is stiff.

As illustrated in FIG. 6, the substrate 11 includes a first sheet 111 made of PVC material in which plasticizer is added so that the first sheet 111 is flexible, a second sheet 112 located on the first sheet 112 and made of PVC material in which vesicant is added so that the second sheet 112 is flexible, and a third sheet 113 located on the second sheet 112, wherein the third sheet 113 is made of PVC material in which the plasticizer is not added so that the third sheet 112 is stiff.

With reference to FIG. 7, the substrate 11 includes a first sheet 111 made of PVC material in which plasticizer is added so that the first sheet 111 is flexible, a second sheet 112 made of PVC material in which vesicant is not added so that the second sheet 112 is stiff, and a third sheet 113 located on the second sheet 112, wherein the third sheet 113 is made of PVC material in which the plasticizer is added so that the third sheet 112 is flexible.

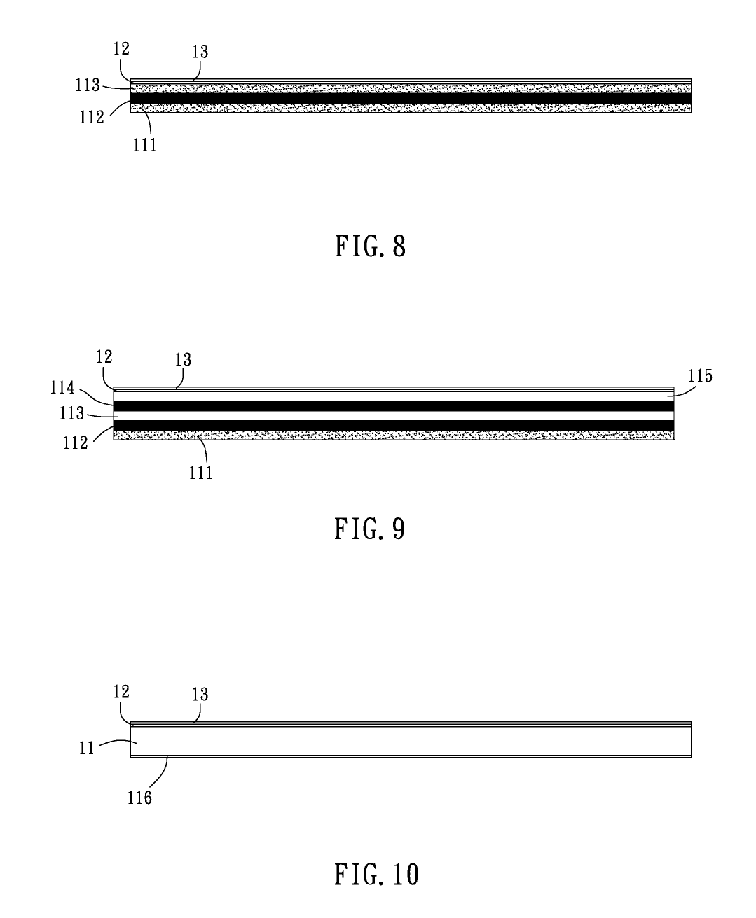

Referring to FIG. 8, the substrate 11 includes a first sheet 111 made of PVC material in which plasticizer is added or is not added, wherein when the plasticizer is added in the PVC material of the first sheet 111, the first sheet 111 is flexible, and when the plasticizer is not added in the PVC material of the first sheet 111, the first sheet 111 is stiff. In addition, the substrate 11 includes a second sheet 112 located on the first sheet 111 and made of PVC material in which insert gas is fed so that the second sheet 112 foams and is flexible, and a third sheet 113 located on the second sheet 112, wherein the third sheet 113 is made of PVC material in which the plasticizer is added or is not added, wherein when the plasticizer is added in the PVC material of the third sheet 113, the third sheet 113 is flexible, and when the plasticizer is not added in the PVC material of the third sheet 113, the third sheet 113 is stiff.

As shown in FIG. 9, the substrate 11 includes a first sheet 111 made of PVC material in which plasticizer is added so that the first sheet 111 is flexible, a second sheet 112 located on the first sheet 111 and made of PVC material in which vesicant is added so that the second sheet 112 is flexible, a third sheet 113 located on the second sheet 112 and made of PVC material in which the vesicant and the plasticizer are not added so that the third sheet 113 is stiff, a fourth sheet 114 located on the third sheet 113 and made of PVC material in which the vesicant is added so that the fourth sheet 114 is flexible, and a fifth sheet 115 located on the fourth sheet 114, wherein the fifth sheet 115 is made of PVC material in which the vesicant and the plasticizer are not added so that the fifth sheet 115 is stiff.

Referring to FIG. 10, a pattern part 116 is fixed on a bottom of the substrate 11 and is a PVC film configured to enhance anti-slip effect of the plastic flooring 10 and to reduce noises.

The printing layer 12 has patterns printed thereon and is arranged on a top of the substrate 11.

The abrasion resistant layer 13 is transparent and is formed on the printing layer 12 so as to enhance abrasion resistance of the plastic flooring 10.

The extruder 20 has at least one material feeder, and a number of the at least one material feeder corresponds to a number of the at least one sheet of the substrate 11. For example, the extruder 20 has a first material feeder 21, a second material feeder 22, and a third material feeder 23.

Preferably, each of the at least one material feeder is configured to feed material made into each of the at least one sheet. In one embodiment, a material distributor 24 is configured to distribute the material into two of the at least one material feeder so that three sheets form on the substrate 11. In another embodiment, a material distributor 24 is configured to distribute the material into three of the at least one material feeder so that five sheets form on the substrate 11.

The rolling conveyor 30 is mounted on and around a peripheral side of the roller unit 40, and the rolling conveyor 30 includes a first rolling mechanism 31 for rolling the abrasion resistant layer 13, a second rolling mechanism 32 for rolling the printing layer 12, a first pressing mechanism 33 for pressing the abrasion resistant layer 13, a second pressing mechanism 34 for pressing the printing layer 12, and a guiding mechanism 35 for guiding the printing layer 12. The abrasion resistant layer 13 is rolled, pressed, and delivered to the roller unit 40 by way of the second rolling mechanism 32 and the second pressing mechanism 34. The printing layer 12 is rolled, pressed, and delivered to the roller unit 40 by means of the second rolling mechanism 32, the second pressing mechanism 34, and the guiding mechanism 35.

The roller unit 40 includes four rollers (i.e., a first roller 42A, a second roller 42B, a third roller 43, and a fourth roller 44) and a support frame 41, wherein the first roller 42A is fixed on a lower end of the support frame 41, the second roller 42B is located on the first roller 42A, the third roller 43 is disposed above the second roller 42B, and the fourth roller 44 is secured on the third roller 43, such that the substrate 11 is extrusion formed by the extruder 20, and the printing layer 12 and the abrasion resistant layer 13 are rolled and pressed together by the rolling conveyor 30. Thereafter, the substrate 11 is guided into the roller unit 40 via the first roller 42A and the second roller 42B, and the substrate 11 is delivered across the third roller 43 and the fourth roller 44 along the second roller 42B. Before the substrate 11 is delivered across the third roller 43 and the fourth roller 44, the printing layer 12 and the abrasion resistant layer 13 are conveyed to the roller unit 40 by the rolling conveyor 30 so that the printing layer 12 stacks on the substrate 11, and the abrasion resistant layer 13 stacks on the printing layer 12, hence the substrate 11, the printing layer 12, and the abrasion resistant layer 13 are rolled and pressed together by the third roller 43 and the fourth roller 44 of the roller unit 40.

To deliver the printing layer 12 and the abrasion resistant layer 13 stably, between a delivery starting position of the printing layer 12 and a pressing position between the third roller 43 and the fourth roller 44 are defined a fifth roller 45 and a sixth roller 46, and between a delivery starting position of the abrasion resistant layer 13 and the pressing position between the third roller 43 and the fourth roller 44 are defined a seventh roller 47 and an eighth roller 48.

Thereby, the plastic flooring 10 is stiff and flexible and is manufactured in an automation manner.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A layering structure of plastic flooring being formed by way of an extruder, a rolling conveyor, and a roller unit, and the plastic flooring comprising a substrate, a printing layer, and an abrasion resistant layer;
wherein the substrate includes at least two sheets which are one-piece extrusion formed by using the extruder so that the at least one sheet stack together;
wherein the printing layer is arranged on a top of the substrate and has patterns printed thereon;
wherein the abrasion resistant layer is formed on the printing layer; and
wherein after the substrate is one-piece extrusion formed, the printing layer and the abrasion resistant layer are conveyed to the roller unit by the rolling conveyor so that the substrate, the printing layer, and the abrasion resistant layer are rolled and pressed together by the roller unit.

2. The layering structure of the plastic flooring as claimed in claim 1, wherein the substrate includes a first sheet made of PVC material in which plasticizer is added so that the first sheet is flexible, and the substrate includes a second sheet located on the first sheet and made of PVC material in which the plasticizer is not added so that the second sheet is stiff.

3. The layering structure of the plastic flooring as claimed in claim 1, wherein the substrate includes a first sheet and a second sheet, the first sheet is made of PVC material in which insert gas is fed so as to foam the first sheet, and the second sheet is made of PVC material in which the plasticizer is added so that the second sheet is flexible.

4. The layering structure of the plastic flooring as claimed in claim 1, wherein the substrate includes a first sheet and a second sheet, the first sheet is made of foam material in which foaming agent is added so that the first sheet 1 is stiff, and the second sheet is made of PVC material in which the plasticizer is added so that the second sheet is flexible.

5. The layering structure of the plastic flooring as claimed in claim 1, wherein the substrate includes a first sheet made of PVC material in which plasticizer is added so that the first sheet is flexible, a second sheet located on the first sheet and made of PVC material in which vesicant is added so that the second sheet is flexible, and a third sheet located on the second sheet and made of PVC material in which the plasticizer is not added so that the third sheet is stiff.

6. The layering structure of the plastic flooring as claimed in claim 1, wherein the substrate includes a first sheet made of PVC material in which plasticizer is added so that the first sheet is flexible, a second sheet made of PVC material in which vesicant is not added so that the second sheet is stiff, and a third sheet located on the second sheet and made of PVC material in which the plasticizer is added so that the third sheet is flexible.

7. The layering structure of the plastic flooring as claimed in claim 1, wherein the substrate includes a first sheet made of PVC material in which plasticizer is added so that the first sheet is flexible, a second sheet located on the first sheet and made of PVC material in which gas is fed so that the second sheet foams and is flexible, and a third sheet located on the second sheet and made of PVC material in which the plasticizer is added so that the third sheet is flexible.

8. The layering structure of the plastic flooring as claimed in claim 1, wherein a pattern part is fixed on a bottom of the substrate and is a PVC film.

9. The layering structure of the plastic flooring as claimed in claim 1, wherein the rolling conveyor includes a first rolling mechanism for rolling the abrasion resistant layer, a second rolling mechanism for rolling the printing layer, a first pressing mechanism for pressing the abrasion resistant layer, a second pressing mechanism for pressing the printing layer, and a guiding mechanism for guiding the printing layer; wherein the abrasion resistant layer is rolled, pressed, and delivered to the roller unit by way of the second rolling mechanism and the second pressing mechanism; wherein the printing layer is rolled, pressed, and delivered to the roller unit by means of the second rolling mechanism, the second pressing mechanism, and the guiding mechanism.

10. The layering structure of the plastic flooring as claimed in claim 1, wherein the roller unit includes a first roller, a second roller, a third roller, a fourth roller, and a support frame, wherein the first roller is fixed on a lower end of the support frame, the second roller is located on the first roller, the third roller is disposed above the second roller, and the fourth roller is secured on the third roller, such that the substrate is guided into the roller unit via the first roller and the second roller, and the substrate is delivered across the third roller and the fourth roller along the second roller, wherein before the substrate is delivered across the third roller and the fourth roller, the printing layer and the abrasion resistant layer are conveyed to the roller unit by the rolling conveyor so that the printing layer stacks on the substrate, and the abrasion resistant layer stacks on the printing layer, hence the substrate, the printing layer, and the abrasion resistant layer are rolled and pressed together by the third roller and the fourth roller of the roller unit.

11. The layering structure of the plastic flooring as claimed in claim 6, wherein the roller unit includes a first roller, a second roller, a third roller, a fourth roller, and a support frame, wherein the first roller is fixed on a lower end of the support frame, the second roller is located on the first roller, the third roller is disposed above the second roller, and the fourth roller is secured on the third roller, such that the substrate is guided into the roller unit via the first roller and the second roller, and the substrate is delivered across the third roller and the fourth roller along the second roller, wherein before the substrate is delivered across the third roller and the fourth roller, the printing layer and the abrasion resistant layer are conveyed to the roller unit by the rolling conveyor so that the printing layer stacks on the substrate, and the abrasion resistant layer stacks on the printing layer, hence the substrate, the printing layer, and the abrasion resistant layer are rolled and pressed together by the third roller and the fourth roller of the roller unit.
